(19) United States
(12) Patent Application Publication
(10) Pub. No.: US 2016/0180447 A1
(43) Pub. Date: Jun. 23, 2016

(54) VIRTUAL SHOPPING

(71) Applicant: eBay Inc., San Jose, CA (US)

(72) Inventors: Shereen Kamalie, Austin, TX (US); Emil Dides, Coppell, TX (US)

(21) Appl. No.: 14/578,414

(22) Filed: Dec. 20, 2014

(51) Int. Cl. G06Q 30/06

(52) U.S. Cl. CPC G06Q 30/0643

(57) ABSTRACT

Techniques for generating a virtual shopping experience are presented herein. A transceiver is configured to receive, from a wearable device, activity information of a user. Additionally, an access module is configured to access an attribute of a user. Moreover, a processor is configured by a fitting room module to receive a garment identifier corresponding to a selected garment. Furthermore, the fitting room module generates an avatar based on the accessed attribute and the received activity information, and obtains a garment model based on the received garment identifier. Subsequently, a display module is configured to cause a presentation of the generated garment model draped on the generated avatar.

### TECHNICAL FIELD

The present application relates generally to the technical field of data processing, specifically, three-dimensional (3-D) modeling and simulation.

### BACKGROUND

A customer may want to purchase a garment without physically trying on the garment at a store. Physically trying on the garment can be a time consuming task. Additionally, when purchasing clothes online, the customer is not able to try on the garment before making a purchasing decision. Since different consumers can have different dimensions, seeing how a garment fits, by use of a digital dressing room, can be a very important aspect of a successful and satisfying shopping experience. Furthermore, it can be helpful for a customer to be able to find other available sizes for a selected garment, and similar garment styles relating to the selected garment, without having to search the store.

In some instances, the customer may have a wearable device, such as an activity tracker. The wearable device can monitor the health and the physical activity of the customer. The customer may want motivation (e.g., incentive to fit into a smaller-sized garment) for a more physically active lifestyle, which can be tracked using the wearable device.

### BRIEF DESCRIPTION OF THE DRAWINGS

FIG. 1 is a schematic diagram illustrating an example system for generating a virtual fitting room, in accordance with certain example embodiments.

FIG. 2 is a block diagram illustrating an example model database, in accordance with certain example embodiments.

FIG. 3 is a network diagram illustrating a network environment suitable for a social network, in accordance with certain example embodiments.

FIG. 4 is a flow diagram of a process for generating a digital wardrobe, in accordance with certain example embodiments.

FIG. 5 is a flow diagram of a process for locating a garment with an identified degree of similarity to a selected garment, in accordance with certain example embodiments.

FIG. 6 is a flow diagram of a process for generating a forecast model for the user based on received activity information, in accordance with certain example embodiments.

FIG. 7 is a flow diagram of a process for determining a target activity threshold based on a target size, in accordance with certain example embodiments.

FIG. 8 is a block diagram illustrating components of a machine, according to some example embodiments, able to read instructions from a machine-readable medium and perform any one or more of the methodologies discussed herein.

### DESCRIPTION OF EMBODIMENTS

Example systems and methods for generating a digital garment draped on an avatar of a user are described. For example, a customer shopping in a retail environment can scan a barcode of a garment to upload a garment model from a digital database. Additionally, a body model (e.g., avatar) can be generated for the customer. By draping the garment model on the body model, a customer can visualize a look and fit of the garment model or visualize the garment module in conjunction with other garments and accessories picked from the retail environment. To address this, techniques described herein generate a digital dressing room using a digital dressing room module. The digital dressing room module can be stored on a mobile device or a cloud server.

By creating a digital dressing room, the user can reduce shopping time and the effort of trying on clothes. For example, a user (e.g., customer) can scan the barcode of a selected garment using a mobile device. In response to user input (e.g., scanning of the barcode), the digital dressing room can present on a display of the mobile device how the garment fits on the user in real time, and without a fitting room.

Additionally, the digital dressing room can present other available sizes in the retail environment based on the selected garment. For example, in response to a user scanning the barcode of a pair of jeans, one or more different sizes of the selected pair of jeans can be displayed on the mobile device.

Moreover, other garments (e.g., garments with style similar to the selected garment) available in the retail environment can be presented based on the selected garment. In some instances, the other garments' locations can be displayed on the mobile device.

A retail environment, such as a retail store, can aggregate garment data on the available garments and accessories in the retail store. The garment data can include, but is not limited to, weight, color, material, ownership information, and manufacturing information. The garment data can be stored in a garment database accessible by the digital fitting room module, also referred to herein as the fitting room module.

For example, a user can select a garment by scanning a barcode or garment tag using a mobile device. The fitting room module can present the selected garment draped on a user-specific avatar. The user-specific avatar can be a virtual prototype of the user's body type based on user input of weight, height, waist measurements, and so on. In some instances, the user input can be a photograph of the user.

The fitting room module can present a specific fit of the garment on a display of a mobile device. For example, based on a size, material, and particular specifications the garment, the fitting room module can simulate the garment model for the garment draped on the avatar. By presenting the garment model draped on the avatar in real time, the user can visualize the actual fit of the garment. Accordingly, the user is instantly able to tell whether the garment is a good fit.

Additionally, the fitting room module can present the garment model draped on the avatar based on different body composition. For example, the garment model can be draped on a user-specific avatar that is a predetermined number (e.g., ten) of pounds less or more than the user's current weight. In some instances, based on some received attributes (e.g., height, weight), the fitting room module can determine the suggested weight corresponding to each garment size.

According to some embodiments, a forecast module, using the wearable device, can forecast the weight of a user at a predetermined time in the future. By tracking current and past activities of the user, calories burned, and other activity information, the forecast module can predict whether a user is going to lose or gain weight. Additionally, the fitting room module can present how the article of clothing will fit based on the forecasted weight.

Furthermore, the fitting room module can accumulate a list of garments that the user has liked, disliked, bought, or want to keep on a wish list. This allows the user to keep track of purchases and compare different articles of clothing from different stores. In some instances, when trying on a garment in a retail environment, it can be difficult for a user to see how the garment matches another garment on the user's wish list. The fitting room module can access a wardrobe model database which includes garment models of garments owned by the customer.

A user interface can be presented to a user (e.g., customer) to scroll through the different garments in a digital wardrobe. For example, a customer scans the barcode of a pair of jeans that the customer may purchase. Continuing with the example, the user interface on the mobile device allows the customer to scroll through different shirts owned by the customer. The customer can swipe through the different shirts to visualize how the pair of jeans and a shirt would look together. Multiple garment models (e.g., a garment model for the pair of jeans and a garment model for a shirt) can be draped on the body model, and the draped model can be presented on the display of the mobile device.

Furthermore, in a feedback example, a first user can share part of the fitting room module with a second user. For example, the fitting room module can share the selected garment on a social network of the user. Subsequently, the fitting room module can receive input from the second user about the selected garment. In some instances, the second user can have access to the user's body model and the digital wardrobe and directly provide feedback of a garment. The feedback can include whether the second user likes or dislikes the garment draped on the user's avatar. Continuing with the feedback example, rendered images can be presented to show how a particular garment matches with other garments in the user's wardrobe, and the second user can provide feedback based on the presentation.

Moreover, based on the digital wardrobe and the body model, the user interface can present a recommended size for a garment available in the retail environment. For example, the second user can scan the barcode of a garment, and the user interface can present a recommended size for the garment based on the user attributes and garments purchased by the user.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. However, it will be evident, to one skilled in the art, that the present subject matter may be practiced without these specific details.

Reference will now be made in detail to various example embodiments, some of which are illustrated in the accompanying drawings. In the following detailed description, numerous specific details are set forth in order to provide a thorough understanding of the present disclosure and the described embodiments. However, the present disclosure may be practiced without these specific details.

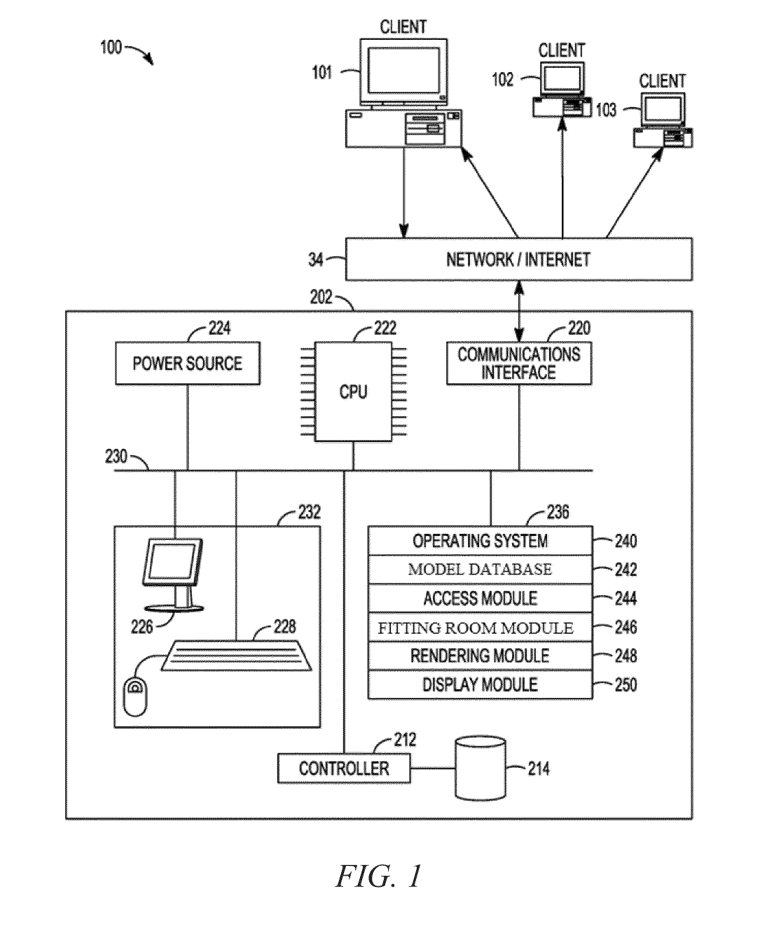

FIG. 1 is a block diagram illustrating a network environment 100 in accordance with example embodiments. The network environment 100 includes client devices (e.g., a client device 101, a client device 102, a client device 103) connected to a server 202 via a network 34 (e.g., the Internet). The client device 101 can be associated with a first user with the selected garment and the fitting room module. The first user can share the selected garment and the digital fitting room to other users via a social network system. The client device 102 can be associated with a second user that has access to the selected garment and the fitting room module corresponding to the first user. Furthermore, the client device 103 can be associated with a third user that does not have access to the selected garment or the fitting room module corresponding to the first user.

The server 202 may include one or more processing units (CPUs) 222 for executing software modules, programs, or instructions stored in a memory 236 and thereby performing processing operations; one or more communications interfaces 220; the memory 236; and one or more communication buses 230 for interconnecting these components. The communication buses 230 may include circuitry (e.g., a chipset) that interconnects and controls communications between system components. The server 202 also optionally includes a power source 224 and a controller 212 coupled to a mass storage 214. In some instances, the mass storage 214 can include a model database 242. The network environment 100 optionally includes a user interface 232 comprising a display device 226 and a keyboard 228.

The memory 236 may include high-speed random access memory, such as dynamic random-access memory (DRAM), static random-access memory (SRAM), double data rate random-access memory (DDR RAM), or other random-access solid state memory devices. Additionally, the memory 236 may include non-volatile memory, such as one or more magnetic disk storage devices, optical disk storage devices, flash memory devices, or other non-volatile solid state storage devices. The memory 236 may optionally include one or more storage devices remotely located from the CPU 222. The memory 236 or, alternately, the non-volatile memory device within the memory 236, may be or include a non-transitory computer-readable storage medium.

In some example embodiments, the memory 236, or the computer-readable storage medium of the memory 236, stores the following programs, modules, and data structures, or a subset thereof: an operating system 240; a model database 242; an access module 244; a fitting room module 246; a rendering module 248; and a display module 250.

The operating system 240 is configured for handling various basic system services and for performing hardware-dependent tasks.

The model database 242 can store and organize various databases utilized by various programs. The model database 242 can store a digital fitting room of a user. The digital fitting room can contain the garment models of the garments owned by the first user. Additionally, the digital fitting room can contain garment models of garments available for purchase in a retail environment, and garment models of garments on the wish list of the user. Furthermore, the model database 242 can store the avatar (or body model) of the first user. The avatar can be generated based on the attributes of the user, which can be received via user inputs.

The access module 244 can communicate with client devices (e.g., the client device 101, the client device 102, or the client device 103) via the one or more communications interfaces 220 (e.g., wired, or wireless), the network 34, other wide area networks, local area networks, metropolitan area networks, and so on. Additionally, the access module 244 can access information for the memory 236 via the one or more communication buses 230. The access module 244 can access information stored in the server 202 (e.g., the model database 242). Additionally, when the digital fitting room or avatar is stored in the client device 101, the access module 244 can access the user's information in the client device 101 via the network 34. Alternatively, when the digital fitting room or avatar is stored on a cloud-server, the access module 244 can access the user's information in the cloud-server via the network 34.

The fitting room module 246 can drape the garment model on the avatar. Moreover, the fitting room module 246 can generate a fit map based on the positioning of the avatar inside the garment model. The fit map can be presented on a mobile device to show a user how the selected garment fits on the user without the user having to physical try on the select garment in a fitting room.

The rendering module 248 can generate an image of one or more garment models draped on the avatar of the user. For example, the rendering module 248 can generate an image of a pair of jeans selected from a first store and a shirt stored in the wish list of the user draped on the avatar.

The display module 250 is configured to cause presentation of the generated image on a display of a device (e.g., client device 101). For example, the display module 250 can present a 3-D simulation on the display of mobile device. The 3-D simulation can be based on the operations of the fitting room module 246 and the rendering module 248.

The network 34 is any network that enables communication between or among machines, databases, and devices (e.g., the server 202 and the client device 101). Accordingly, the network 34 may be a wired network, a wireless network (e.g., a mobile or cellular network), or any suitable combination thereof. The network 34 may include one or more portions that constitute a private network, a public network (e.g., the Internet), or any suitable combination thereof. Accordingly, the network 34 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or a WiMAX network), or any suitable combination thereof. Any one or more portions of the network 34 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

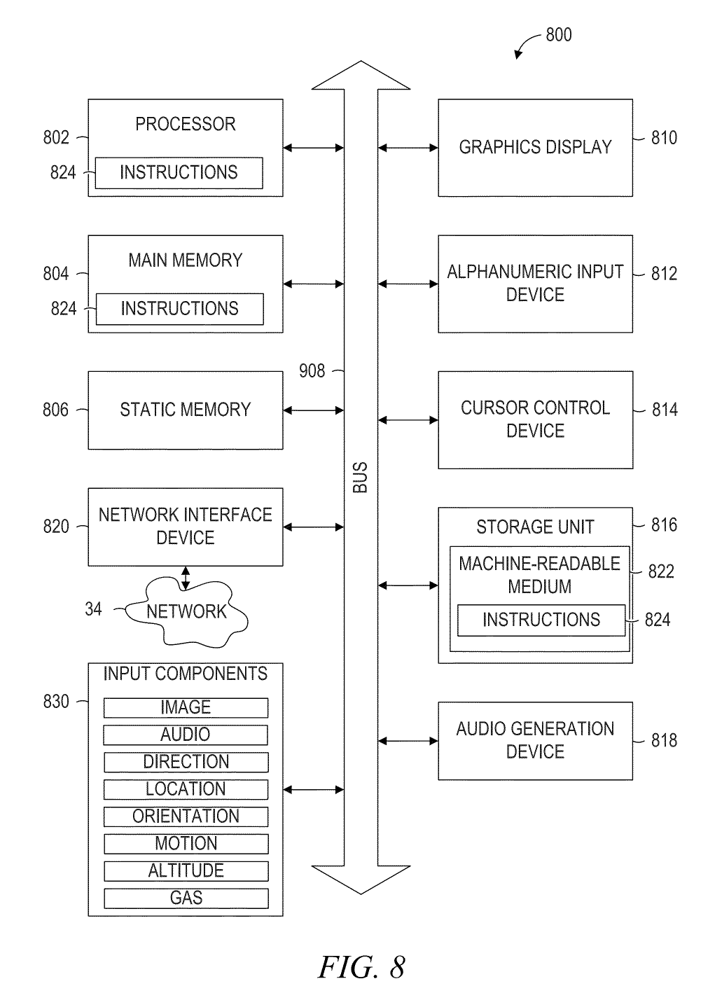

The server 202 and the client devices (e.g., the client device 101, the client device 102, and the client device 103) may each be implemented in a computer system, in whole or in part, as described below with respect to FIG. 8. Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

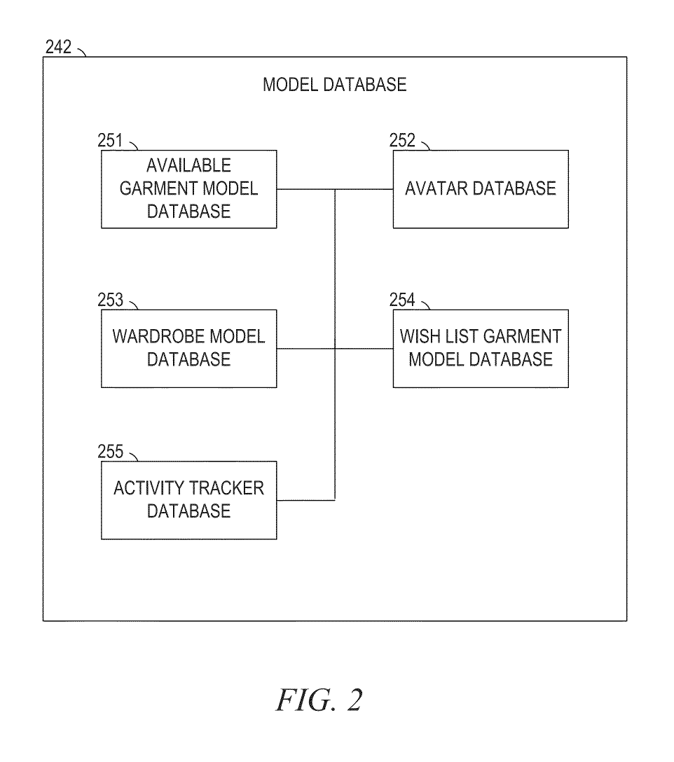

FIG. 2 further describes an element of the memory 236 in the server 202, as initially described in FIG. 1. FIG. 2 includes an expanded depiction of the model database 242. The model database 242 may store one or more of the following databases: available garment model database 251; avatar database 252; wardrobe model database 253, a wish list model database 254; and an activity tracker database 255.

The available garment model database 251 comprises garment models of garments available in the retail environment. The merchant can update the available garment model database 251 based on current merchandise inventory in the store. As previously discussed, the barcode of a garment available in a store contains information about the garment. The fitting room module 246 can generate a garment model of the garment in the store based on the barcode of the garment. The available garment model database 251 can be accessed by the public or a user geo-located in the merchant store. The available garment model database 251 can be stored in a server managed by the merchant.

The avatar database 252 stores the avatar (e.g., body model) of the user. In one embodiment, the fitting room module 246 generates the avatar based on received attributes (e.g., height, weight, or photograph of the user), and stored the avatar in the avatar database 252. The avatar database 252 can be stored on the server 202 or the client device 101.

The wardrobe model database 253 includes garment models of the garments purchase by the user. For example, when a user scans the barcode of a garment in available in store and then purchases the garment, the garment model of the purchased garment is stored in the wardrobe model database 253. The wardrobe model database 253 can be stored on the server 202 or the client device 101.

The wish list model database 254 includes garment models of garments on the user's wish list. For example, when a user scans a barcode of an available garment in the store but does not buy the garment, the garment model of the scanned garment is stored in the wish list model database. The wish list model database 254 can be updated (e.g., add or remove garment models) using a user interface on a mobile device. The wish list model database 253 can be stored on the server 202 or the client device 101.

The activity tracker database 255 includes activity information received from a wearable device. The activity information can include the heart rate of the user, calories burned, number of daily steps taken by the user, stairs climbed, quality of sleep, weight, body mass index (BMI), and percentage of body fat of the user. The fitting room module 246 can use the activity information stored in the activity tracker database 255 to present an overview of physical activity, set and track goals, and keep food and activity logs.

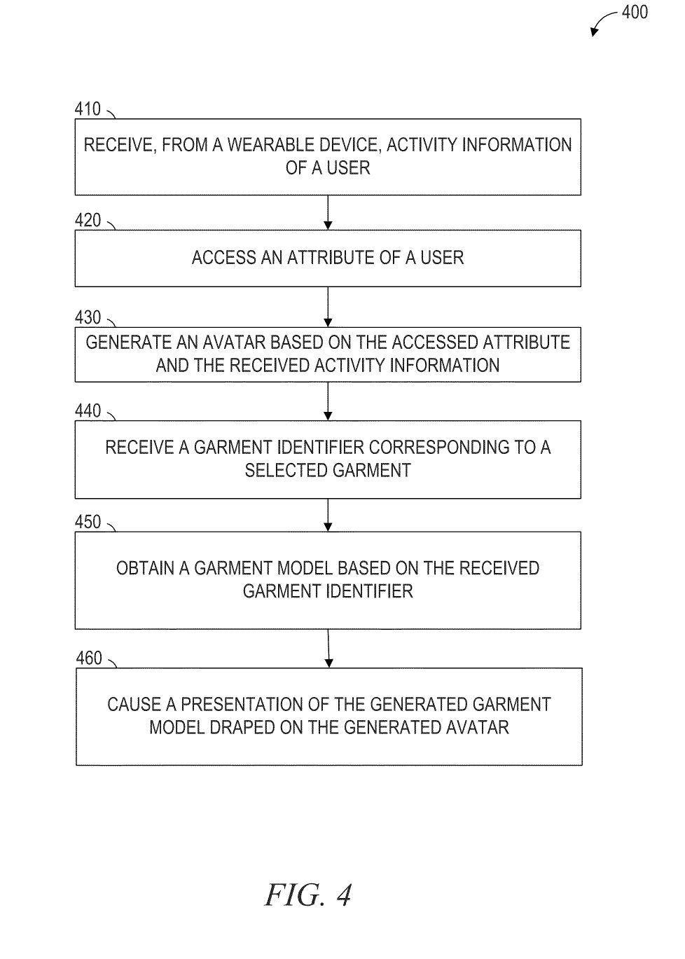

In some instances, part of the model database 242 (e.g., avatar database 252, wardrobe model database 253, wish list model database 254, and activity tracker database 255) is stored in the server 202. Alternatively, part of the model database 242 (e.g., avatar database 252, wardrobe model database 253, wish list model database 254, and activity tracker database 255) can be stored in the client device 101. For example, for security reasons, the avatar database 252 and the wardrobe model database 253 can be stored on the client device 101, and only accessed by authorized users (e.g., user of client device 102, or users connected to the first user in a social network system). FIG. 4 further describes operations using the model database 242 from FIG. 2.

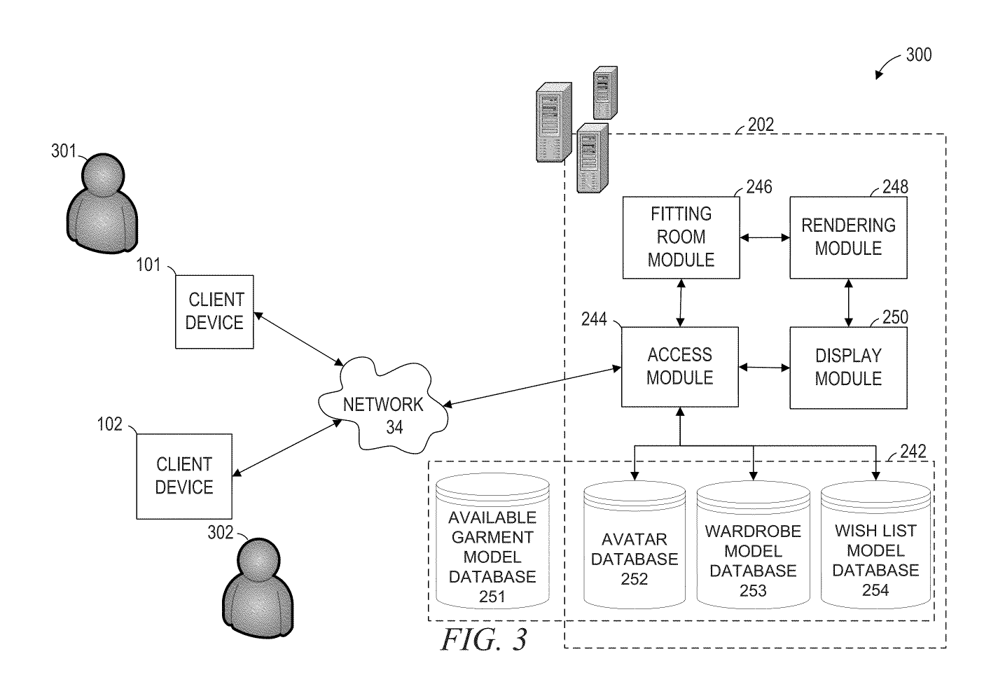

FIG. 3 is a network diagram illustrating a network environment 300 suitable for a social network, according to some example embodiments. The network environment 300 includes the server 202 with the fitting room module 246 and the model database 242. The model database 242 includes the avatar database 252, the wardrobe model database 253, and the wish list model database 254 that can be stored in the server 202. The available garment model database 251 can be stored in a server managed by the merchant, and the garment models can be accessed using the scanned barcode information.

The server 202 can be a cloud-based server system configured to provide one or more services to the client devices 101 and 102. The server 202, the client device 101, and the client device 102 may each be implemented in a computer system, in whole or in part, as described below with respect to FIG. 8.

In some instances, a first user 301 (e.g., customer), using the client device 101, sends a request, to the server 202, to view how a garment available for purchase fits an avatar specific to the user. The request can be initiated by scanning the barcode of the garment available for sale at the merchant store. The barcode can include a garment identifier, which is used to access the garment model corresponding to the selected garment from the available garment model database 251. In some instances, the request can include a user identifier which is a unique identifier of the client device 101 (e.g., media access control (MAC) address.

International Mobile Station Equipment Identity (IMEI)). For example, the user identifier can be used to determine the user and access their avatar. The access module 244 retrieves a first garment model corresponding to the request using the garment identifier from the available garment model database 251. The first garment model can include information about the garment, such as weight, color, material, availability in other stores, availability in other colors, and availability in other sizes. Additionally, the access module 244 can retrieve the avatar corresponding to the user identifier from the avatar database 252. Furthermore, in some instances, the access module 244 can retrieve a second garment model from the wardrobe model database 253 or the wish list model database 254. The wardrobe model database 253 corresponds to the wardrobe of the first user 301 and can be accessed if the user identifier is permitted to access the wardrobe model database 253. Similarly, the wish list model database 254 can be accessed if the user identifier is permitted to access the wish list model database 254 (e.g., the user 301 shares the garment in the wish list to friends in the user's social network).

In order to fulfill the user request, the fitting room module 246, the rendering module 248, and the display module 250 receives the first and second garment models and the avatar model from the access module 244 to implement the operations described in method 400 of FIG. 4.

Also shown in FIG. 3, the first user 301 and the second user 302 may each be a human user (e.g., a human being), a machine user (e.g., a computer configured by a software program to interact with the client device, or any suitable combination thereof (e.g., a human assisted by a machine or a machine supervised by a human). For example, the client device 101 may be a desktop computer, a vehicle computer, a tablet computer, a navigational device, a portable media device, a smartphone, or a wearable device (e.g., activity tracker, a smart watch, or smart glasses) belonging to the user 301.

Additionally, the actual number of servers 202 used to implement the access module 244, the fitting room module 246, the rendering module 248, and the display module 250, as well as how features are allocated among them will vary from one implementation to another, and may depend in part on the amount of data traffic that the network environment 300 handles during peak usage periods as well as during average usage periods.

FIG. 4 is a flowchart representing a method 400 for generating a digital wardrobe, according to example embodiments. The method 400 is governed by instructions stored in a computer-readable storage medium and that are executed by one or more processors of one or more servers 202. Each of the operations shown in FIG. 4 may correspond to instructions stored in a computer memory 236 or a computer-readable storage medium. Operations in the method 400 may be performed by the server 202, using modules described above with respect to FIGS. 1-3. As shown in FIG. 4, the method 400 includes operations 410, 420, 430, 440, 450, and 460.

At operation 410, the access module 244 receives, from a wearable device, activity information of user. The activity information can include the heart rate of the user, calories burned, number of daily steps taken by the user, stairs climbed, quality of sleep, and other personal metrics. The wearable device can be a wireless-enabled wearable device, such as a wristband, that includes a three-dimensional accelerometer, an altimeter, and a heart-rate monitor. In some instances, the wearable device measures weight, body mass index (BMI), and percentage of body fat of the user. The wearable device can also include a smart watch or smart glasses.

For example, the wearable device can measure steps taken, and combine this measure with user data to calculate activity information (e.g., distance walked, calories burned, floors climbed, and activity duration and intensity). The activity information can be uploaded to the access module 244 and the fitting room module 246. The activity information can be received from a user using the communications interface 220 via the network 34.

At operation 420, the access module 244 accesses an attribute of the user. An attribute of a user can include the height of the user, the gender of the user, the weight of the user, a garment size, the body type of the user, neck size, arm length, chest size, waist size, and leg length. In some instances, the attributes can be received via a user input on a user interface. Additionally, a photograph of the user can be received, and the attributes determined by the fitting room module 246 based on the photograph. The attributes can be received from a user using the communications interface 220 via the network 34. The attributes can be stored in the avatar database 252.

In operation 430, the fitting room module 246 generates an avatar based on the accessed attribute from operation 420 and the received activity information from operation 410. The accessed attribute can include body measurements. For example, the body measurement can include neck size, arm length, chest size, waist size, leg length, and so on. The avatar can be generated using multiple body measurements. For example, the list of body measurements for a man can include weight, height, chest, waist, and inseam. The list of body measurements for a woman can include weight, height, bust, waist, and hips. The fitting room module 246 generates an avatar for the user based on these measurements. The list of parameters is just representative, and is not intended to be exhaustive. The body measurement of the user can be received via user input or stored in the avatar database 252. The body measurements can be received using the communications interface 220 via the network 34.

In some instances, the accessed attributes is derived from an uploaded image of the body of a user (e.g., photograph). Accordingly, the avatar is generated by scanning the image of the body, and determining the dimensions of the body based on the scanned image. The user can upload the images of the user or user dimensions using the communications interface 220 via the network 34.

Additionally, the avatar can be generated based on the received activity information from the wearable device. The fitting room module 266 can determine an overview of physical activity for the user, keeping food and activity logs. Using the activity information, the avatar can be updated or modified. For example, even though the body measurements may have been inputted by the user in the past (e.g., last month), the fitting room module 266 can still determine an accurate representation of the current dimensions of the user's body based on the activity information received from the wearable device. Using the activity information, the fitting room module 266 can determine if the user has gained or lost weight. Furthermore, in some instances, based on the type of activities, the fitting room module 266 can determine which body measurements (e.g., arm size versus waist size) have changed based on the change of body weight.

The generated avatar is stored in the avatar database 252. In some instances, the body model of a first user is stored on a cloud server for users, including other users connected to the first user via a social network, to retrieve using a mobile device. In some other instances, the body model is stored on a third-party server of a merchant that a user can access when browsing a virtual fitting room.

At operation 440, the access module 244 receives a garment identifier corresponding to a selected garment. In one embodiment, the garment identifier is derived from the barcode on the garment tag of the garment at the merchant store. Additionally, the garment model can be a model of a clothing accessory (e.g., gloves, shoes, tie, scarf, belt, and watch). The garment identifier can also include the brand, style number, and color of the garment. The garment identifier can be a unique identifier that the fitting room module 246 uses to retrieve the garment information in order to generate a garment model corresponding to the garment. The garment identifier can be stored in the model database 242. The garment identifier can be received from a user using the communications interface 220 via the network 34. In some instances, the garment identifier can be previously stored and accessible by the access module 244.

At operation 450, the fitting room module 246 can obtain a garment model based on the received garment identifier. The garment model can be obtained from the model database 242. In some instances, the garment model can be generated by the fitting room module 246. As previously mentioned, the garment can be available for sale in a merchant store. Additionally, the garment identifier can be obtained by scanning a garment tag (e.g., barcode) of the first garment.

The garment model of a garment can be a three-dimensional garment model that includes garment points that represent a surface of the garment. For example, the garment model can be a tessellated three-dimensional garment model. The tessellated three-dimensional garment model can include a group of vertices associated with points on the surface of the garment.

The fitting room module 246 accesses the garment model from the available garment model database 251 using the garment identifier (e.g., barcode). As previously mentioned, the available garment model database 251 can be maintained by the merchant. For example, the merchant or manufacturer can upload garment models of garments available in the merchant's store to the available garment model database 251. Subsequently, the fitting room module 246, using the garment identifier, retrieves the garment model corresponding to the garment identifier.

In some instances, the available garment model database 251 includes previous ownership information about the garment. For example, when the merchant is a consignment store, the barcode can include previous ownership information of the garment.

Additionally, the garment model can be generated by the fitting room module 246 using garment measurements. The garment measurements can be retrieved from the available garment model database 251 using the garment identifier. Moreover, the garment model can be generated by the fitting room module 246 using images of the garment. A garment model corresponding to a garment identifier can be accessed from a database (e.g., available garment model database 251, wardrobe model database 253, wish list model database 254) using the communications interface 220 via the network 34.

The wardrobe model database 253 can have garment models of garments in a wardrobe of the user. The garment model of a garment purchased by the user can automatically be uploaded to the wardrobe database 253. The wardrobe database 253 can be stored on cloud-based servers. For example, any user that is authorized to access information corresponding to the user identifier can access the information from the cloud-based server via the network 34. Alternatively, the wardrobe model database 253 can be stored on a mobile device (e.g., client device 101).

In some instances, the wardrobe model database 253 stores the garment models of garments owned by the user. The user can upload the garment to the wardrobe model database 253 by uploading photos of the garments or scanning the garment tag to upload the garment to the wardrobe model database 253. Additionally, the garment can automatically be uploaded to the wardrobe model database 253 when the user purchases a garment online. For example, when the user logs into the user's account with an online merchant and purchases a garment, the online merchant transmits the garment identifier and the user identifier to the fitting room module 246.

At operation 460, the fitting room module 246, the rendering module 248, and the display module 250 can cause a presentation of the generated garment model draped on the generated avatar. In some instances, the fitting room module 246 and the rendering module 248 causes the garment model to be rendered on the avatar. Subsequently, the display module 250 causes the presentation of the garment model rendered on the avatar on the display of a mobile device. The fitting room module 246 and the rendering module 248 can configure at least one processor among the one or more processors (e.g., the CPU 222) to render the garment model on the avatar.

Additionally, the fitting room module 246 can simulate the garment model on a generated user avatar. In some instances, simulation of the garment can include placing the garment around the body at an appropriate position, and running simulations. The simulation can advance the position and other related variables of the vertices of the garment based on different criteria (e.g., garment material properties, body-garment friction force, elasticity of material, and gravitational force).

The rendering module 248 can generate an image of the garment model draped on the avatar based on the simulation results received from the fitting room module 246. The rendering module 248 can configure at least one processor among the one or more processors (e.g., the CPU 222) to generate the image at operation 460.

The display module 250 can present the generated image on a display of a device. The display module 250 can configure the user interface 232 for the presentation. The display module 250 can configure at least one processor among the one or more processors (e.g., the CPU 222) to present the generated image on the display of a mobile device.

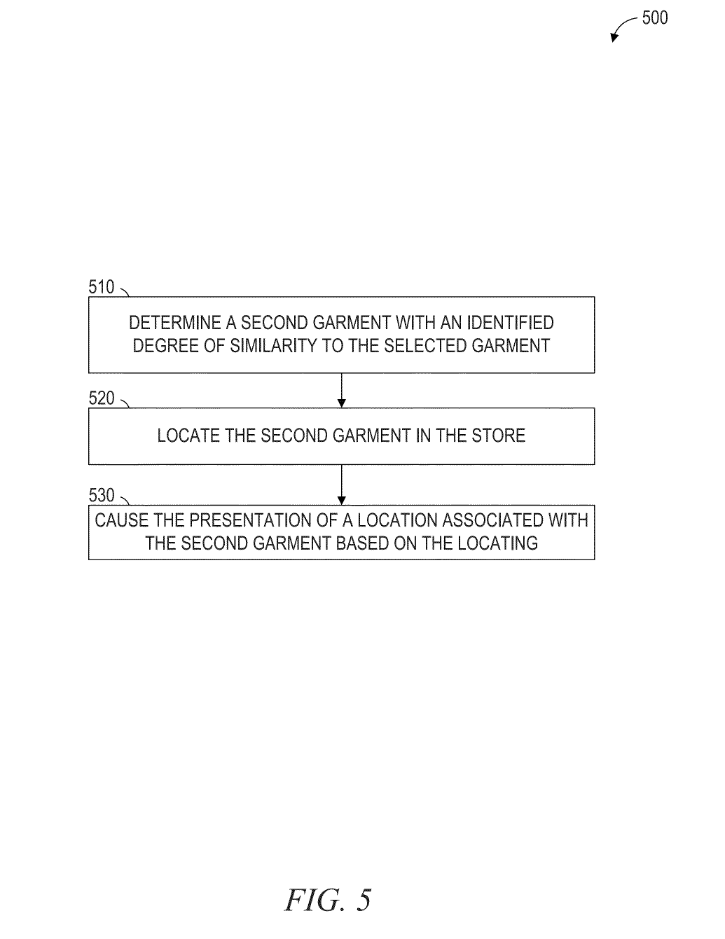

FIG. 5 is a flowchart representing a method 500 for locating a garment with an identified degree of similarity to the garment selected at operation 430, according to example embodiments. The method 500 is governed by instructions stored in a computer-readable storage medium and that are executed by one or more processors of one or more servers 202. Each of the operations shown in FIG. 5 may correspond to instructions stored in a computer memory 236 or computer-readable storage medium. Operations in the method 500 may be performed by the server 202, using modules described above with respect to FIGS. 1-3. As shown in FIG. 5, the method 500 includes operations 510, 520, and 530.

At operation 510, the fitting room module 246 determines a second garment with an identified degree of similarity to the selected garment. The identified degree of similarity can be based on a style and size of the selected garment, past purchase history (e.g., cost of garment when previously purchased), manufacturer's recommendation, merchant recommendation, and attributes of the user. The second garment can be located in a merchant store. In some instances, using the available garment model database 251, the fitting room module 246 determines the garments that are currently available in the merchant store. Using machine-learning algorithms, the fitting room module 246 determines a second garment to present to the user. For example, based on a shirt selected by the user, the fitting room module 246 recommends pants to match the shirt or another shirt with similar style.

At operation 520, the fitting room module 246 locates the second garment in the merchant store. In some instances, the merchant can geotag the location of the garment in the store by adding geographical identification to the garment model stored in the available garment model database 251. The fitting room module 246 can locate the second garment based on the geotag. Alternatively, the garment can have a location tag (e.g., Radio-frequency identification (RFID) tag). The fitting room module 246 can use indoor position techniques to locate the garment based on the location tag of the garment. The indoor positioning technique locates the garment and the mobile device inside the store using radio waves, magnetic fields, acoustic signals, or other sensory information collected by the mobile device.

At operation 530, the display module 250 causes the presentation of a location associated with the second garment based on the locating performed at operation 520. The display module 250 can present a map of the store with the location of the mobile device and the second garment on a display of a device. The display module 250 can configure the user interface 232 for the presentation. The display module 250 can configure at least one processor among the one or more processors (e.g., the CPU 222) to present the generated image on the display of a mobile device.

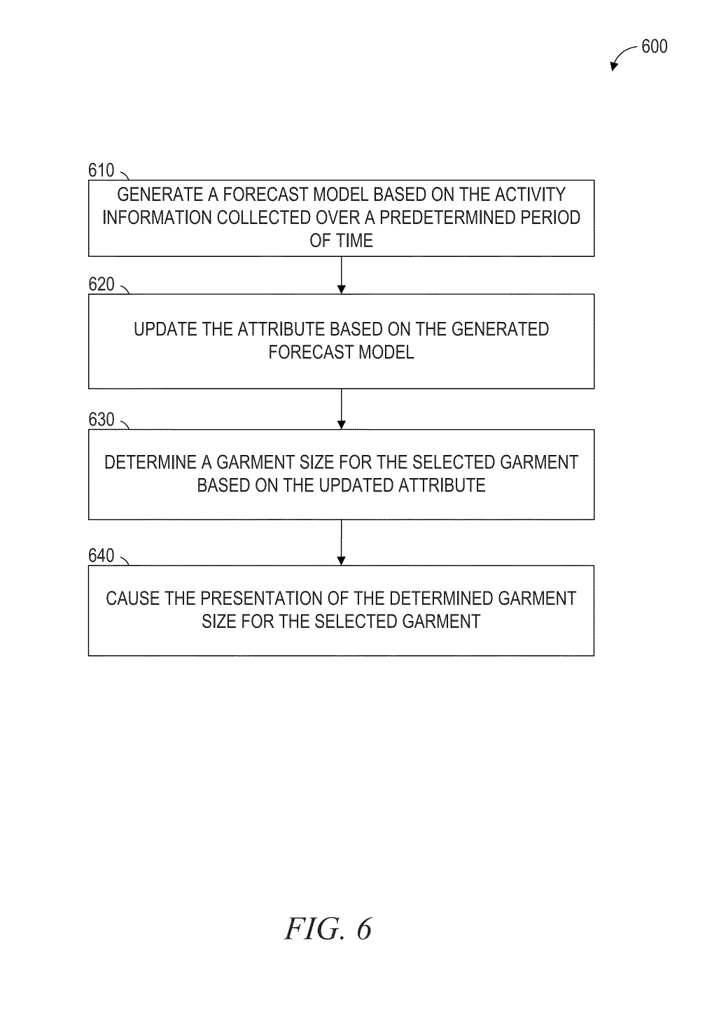

FIG. 6 is a flowchart representing a method 600 for generating a forecast model for the user based on the received activity information, according to example embodiments. The method 600 is governed by instructions stored in a computer-readable storage medium and that are executed by one or more processors of one or more servers 202. Each of the operations shown in FIG. 6 may correspond to instructions stored in a computer memory 236 or computer-readable storage medium. Operations in the method 600 may be performed by the server 202, using modules described above with respect to FIGS. 1-3. As shown in FIG. 6, the method 600 includes operations 610, 620, 630 and 640.

At operation 610, the fitting room module 246 generates a forecast model for the user based on the activity information received from the wearable device at operation 410. The activity information (e.g., steps taken, calories burned, sleep quality, and heart rate) can be collected by the wearable device over a predetermined period of time (e.g., days, weeks, and months). Additionally, the collected activity information can be stored in the avatar database 252.

At operation 620, the fitting room module 246 updates the attribute based on the generated forecast model. In some instances, an attribute (e.g., weight, or waist size) may have been received from a user in the past (e.g., two weeks ago). Using the generated forecast model, the fitting room module 246 determines an updated attribute (e.g., weight, or waist size) for the user. For example, based on the calories burned, calorie intake, sleep schedule, and the number of steps taken, the fitting room module 246 determines if the user has lost or gained weight.

At operation 630, the fitting room module 246 determines a garment size for the selected garment based on the updated attribute. Additionally, the garment size can be further based on the garment information accessed from the model database 242 (e.g., available garment model database 251). For example, when determined that the user has lost an estimated number of pounds, based on a forecast model, the fitting room module 246 determines that the user has dropped a dress size.

At operation 640, the display module 250 causes the presentation of the determined garment size for the selected garment to the user. The display module 250 presents the determined garment size, the selected garment model draped on the avatar, and the location of the garment with the determined garment size. The display module 250 can configure the user interface 232 for the presentation. The display module 250 can configure at least one processor among the one or more processors (e.g., the CPU 222) to present the generated image on the display of a mobile device.

In various example embodiments, the fitting room module 246 updates the attribute based on the activity information. For example, based on the forecasting model generated in method 600, the fitting room module 246, determines that the user has lost weight or dropped a dress size. Therefore, the attribute (e.g., weight, dress size) is updated. Additionally, the fitting room module 246 can determine a new garment size for the garment based on the updated attribute. Subsequently, the display module 250 can notify the user that the garment is available for purchase in the new garment size.

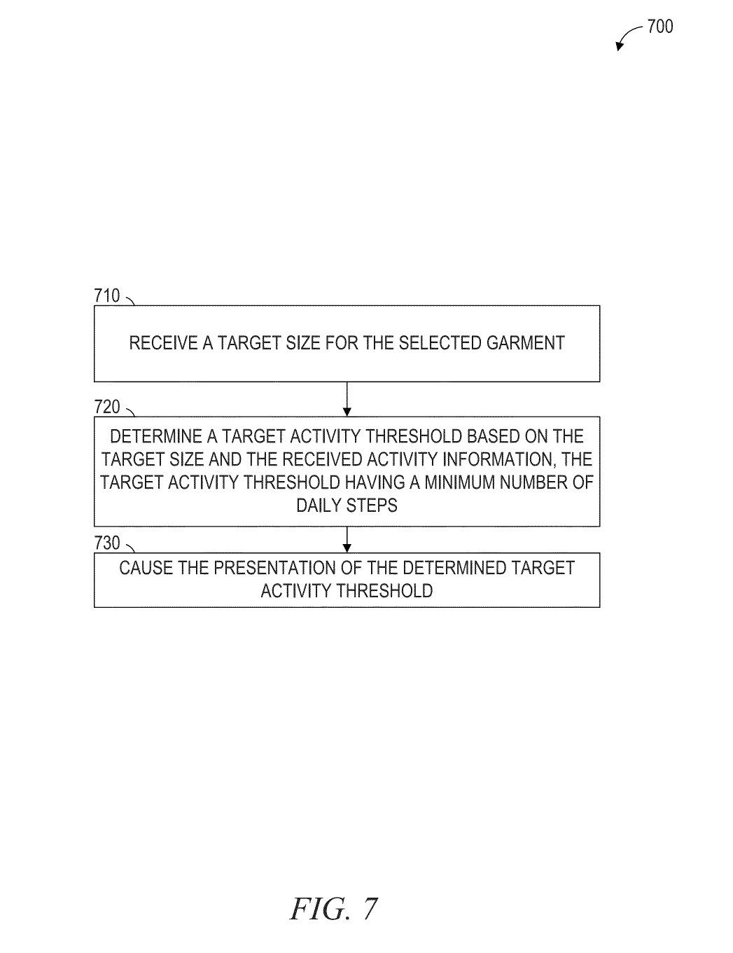

FIG. 7 is a flowchart representing a method 700 for determining a target activity threshold based on a target size, according to example embodiments. The method 700 is governed by instructions stored in a computer-readable storage medium and that are executed by one or more processors of one or more servers 202. Each of the operations shown in FIG. 7 may correspond to instructions stored in a computer memory 236 or computer-readable storage medium. Operations in the method 700 may be performed by the server 202, using modules described above with respect to FIGS. 1-3. As shown in FIG. 7, the method 700 includes operations 710, 720, and 730.

At operation 710, the access module 244 receives a target size for the garment selected at operation 430. For example, a user input of a target size can be received by the user interface 232. In this embodiment, the target size can be a garment size for a garment that the user wants to fit into, such as a wedding dress. The user may select the target size that is smaller than the user's current size, in order to receive motivation with a target activity threshold.

At operation 720, the fitting room module 246 determines a target activity threshold based on the target size and the received activity information. In some instances, the target activity threshold can be further based on the received attributes. The target activity threshold may be based on a minimum number of daily steps to achieve the target size. Additionally the target activity threshold can include any other activity that is measurable by a wearable device. For example, using the forecast model generated in method 600, the fitting room module 246 determines that in order for the user to drop a dress size, the user should take a minimum of 10,000 steps a day.

At operation 730, the display module 250 causes the presentation of the determined target activity threshold. For example, the display module 250 presents a graph of the target activity threshold in order to achieve different target sizes. The display module 250 can configure the user interface 232 for the presentation. The display module 250 can configure at least one processor among the one or more processors (e.g., the CPU 222) to present the generated image on the display of a mobile device.

In various example embodiments, the fitting room module 246 shares the generated garment model on a social network of a first user. The garment model is shared with a second user connected to the first user on the social network. Additionally, the second user can comment and give feedback about the garment to first user.

In various example embodiments, the access module 244 receives a garment size for the garment. Subsequently, the fitting room module 246 determines a first suggested weight based on the received garment size and the accessed attribute. Additionally, the fitting room module 246 can determine a second suggested weight for a second garment size based on the accessed attribute, the second garment size being different than the received garment size. Furthermore, the display module 250 can cause the presentation of the first suggested weight and the second suggested weight.

In various example embodiments, the access module 244 receives a second garment identifier of a second garment. The fitting room module 246 can generate a second garment model based on the second garment identifier. In some instances, the second garment model is stored in the wish list model database 254. Additionally, the display module 250 causes the presentation of a user interface having a wish list, the wish list including the generated garment model and the generated second garment model. As previously mentioned, garments selected by the user, but not purchased by the user, can be stored in the wish list model database 254.

By creating a virtual fitting room, one or more of the methodologies described herein may obviate a need for certain efforts or resources that otherwise would be involved in using a physical fitting room. Computing resources used by one or more machines, databases, or devices (e.g., within the network environment 300) may similarly be reduced. Examples of such computing resources include processor cycles, network traffic, memory usage, data storage capacity, power consumption, and cooling capacity.

FIG. 8 is a block diagram illustrating components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part. The server 202 can be an example of the machine 800.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include any collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, an audio generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered machine-readable media 822 (e.g., tangible and non-transitory machine-readable media). The instructions 824 may be transmitted or received over the network 34 via the network interface device 820. For example, the network interface device 820 may communicate the instructions 824 using any one or more transfer protocols (e.g., hypertext transfer protocol (HTTP)).

The machine-readable medium 822 may include a magnetic or optical disk storage device, solid state storage devices such as flash memory, or other non-volatile memory device or devices. The computer-readable instructions 824 stored on the computer-readable storage medium 822 are in source code, assembly language code, object code, or another instruction format that is interpreted by one or more processors 802.

In some example embodiments, the machine 800 may be a portable computing device, such as a smartphone or tablet computer, and have one or more additional input components 830 (e.g., sensors or gauges). Examples of such input components 830 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown, in an example embodiment, to be a single medium, the term “machine-readable medium” should be taken to include a single medium or multiple media (e.g., a centralized or distributed database, or associated caches and servers 202) able to store the instructions 824. The term “machine-readable medium” shall also be taken to include any medium, or combination of multiple media, that is capable of storing the instructions 824 for execution by the machine 800, such that the instructions 824, when executed by one or more processors 802 of the machine 800 (e.g., the processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

The foregoing description, for purposes of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the present disclosure and its practical applications, to thereby enable others skilled in the art to best utilize the present disclosure and various embodiments with various modifications as are suited to the particular use contemplated.

Throughout this specification, plural instances may implement components, operations, or structures described as a single instance. Although individual operations of one or more methods are illustrated and described as separate operations, one or more of the individual operations may be performed concurrently, and the operations can be performed in a different order than illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 802) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 802 or other programmable processor 802. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 802 configured by software to become a special-purpose processor, the general-purpose processor 802 may be configured as respectively different special-purpose processors (e.g., comprising different hardware modules) at different times. Software (e.g., a software module) may accordingly configure one or more processors 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, a processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines including processors 802), with these operations being accessible via a network 34 (e.g., the Internet) and via one or more appropriate interfaces (e.g., an application program interface (API)).

The performance of certain operations may be distributed among the one or more processors 802, not only residing within a single machine, but deployed across a number of machines. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the arts. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements.” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, from a wearable device, activity information of a user;
accessing an attribute of a user;
generating, using a processor, an avatar based on the accessed attribute and the received activity information;
receiving a garment identifier corresponding to a selected garment;
obtaining a garment model based on the received garment identifier, and
causing a presentation of the generated garment model draped on the generated avatar.

2. The method of claim 1, further comprising:
determining a second garment with an identified degree of similarity to the selected garment, the selected garment and the second garment being located in a store;
locating the second garment in the store using an indoor positioning technique; and
causing a presentation of a location corresponding to the second garment based on the locating.

3. The method of claim 1, further comprising:
sharing the selected garment on a social network of the user, the user being connected to a second user on the social network; and
receiving input from the second user about the selected garment.

4. The method of claim 1, further comprising:
generating a forecasting model based on the activity information collected over a predetermined period of time;
updating the attribute based on the generated forecast model;
determining a garment size for the selected garment based on the updated attribute; and
causing a presentation of the determined garment size for the selected garment.

5. The method of claim 1, further comprising:
receiving a garment size for the garment from the user,
determining a first suggested weight based on the received garment size and the accessed attribute;
selecting a second garment size, the second garment size being different than the received garment size;
determining a second suggested weight for the second garment size based on the accessed attribute; and
causing a presentation of the first suggested weight and the second suggested weight.

6. The method of claim 1, wherein the accessed attribute includes a height measurement, a weight of the user, a waist size, a chest size, or a garment size.

7. The method of claim 1, wherein the accessed attribute is derived from a photograph of the user.

8. The method of claim 1, further comprising:
receiving a user input to retrieve a second garment model from a wish list database, the wish list database having garment models of garments previously selected by the user,
accessing the second garment model from the wish list database,
causing a presentation of a user interface having a wish list, the wish list including the generated garment model and the generated second garment model.

9. The method of claim 1, wherein the garment identifier is obtained from a barcode of the selected garment.

10. The method of claim 9, wherein the barcode references a database having previous ownership information of the garment.

11. The method of claim 9, wherein the barcode references a database having available garment colors and available garment sizes for the garment.

12. The method of claim 1, wherein the garment model is a model of a clothing accessory.

13. The method of claim 1, wherein the activity information includes a heart rate of the user, number of calories burned by the user, or a number of daily steps taken.

14. The method of claim 1 further comprising:
updating the attribute based on the activity information;
determining a new garment size for the garment based on the updated attribute; and
notifying the user that the garment is available for purchase in the new garment size.

15. The method of claim 1, further comprising:
receiving a target size for the selected garment;
determining a target activity threshold based on the target size, the target activity threshold having a minimum number of daily steps; and
causing a presentation of the determined target activity threshold.

16. A system comprising:
a transceiver configured to receive, from a wearable device, activity information of a user;
an access module configured to access an attribute of a user,
a fitting room module configured to:
generate an avatar based on the accessed attribute and the received activity information;
receive a garment identifier corresponding to a selected garment; and
obtain a garment model based on the received garment identifier; and
a display module configured to cause a presentation of the generated garment model draped on the generated avatar.

17. The system of claim 16, wherein the fitting room module is further configured to:
determine a second garment with an identified degree of similarity to the selected garment, the selected garment and the second garment being located in a store;
locate the second garment in the store using an indoor positioning technique; and
the display module is further configured to cause a presentation of a location corresponding to with the second garment based on the locating.

18. The system of claim 16, wherein the fitting room module is further configured to:
generate a forecasting model based on the activity information collected over a predetermined period of time;
update the attribute based on the generated forecast model;
determine a garment size for the selected garment based on the updated attribute; and
the display module is further configured to cause a presentation of the determined garment size for the selected garment.

19. The system of claim 16, wherein the fitting room module is further configured to:
receive a target size for the selected garment;
determine a target activity threshold based on the target size, the target activity threshold having a minimum number of daily steps; and
the display module is further configured to cause a presentation of the determined target activity threshold.

20. A non-transitory machine-readable storage medium comprising instructions that, when executed by one or more processors of a machine, cause the machine to perform operations comprising:
receiving, from a wearable device, activity information of a user;
accessing an attribute of a user;
generating an avatar based on the accessed attribute and the received activity information;
receiving a garment identifier corresponding to a selected garment;
obtaining a garment model based on the received garment identifier, and
causing a presentation of the generated garment model draped on the generated avatar.
